(19) United States
(12) Patent Application Publication
(10) Pub. No.: US 2021/0332903 A1
(43) Pub. Date: Oct. 28, 2021

(54) ON-OFF VALVE

(71) Applicant: FUMOTO GIKEN CO., LTD., Miura-gun (JP)

(72) Inventors: Ryohei YAMAMOTO, Miura-gun (JP); Yuho YAMAMOTO, Miura-gun (JP); Naoyuki YAMAMOTO, Miura-gun (JP)

(73) Assignee: FUMOTO GIKEN CO., LTD., Miura-gun (JP)

(21) Appl. No.: 17/215,621

(22) Filed: Mar. 29, 2021

(30) Foreign Application Priority Data
Apr. 22, 2020 (JP) 2020-076387
Nov. 6, 2020 (JP) 2020-186212

(51) Int. Cl. F16K 21/00; F16K 1/12; F16K 1/36; F16K 27/02; F16K 31/50

(52) U.S. Cl. CPC F16K 21/00; F16K 1/12; F16K 31/504; F16K 27/0245; F16K 1/36

(57) ABSTRACT

An on-off valve includes a valve body housed in a valve body housing portion provided in a main body, the valve body being switchable between an open position and a closed position, an operating means that switch the valve body between the open position and the closed position, a discharge channel, one end of the discharge channel being communicated with a valve chamber of the main body, another end of the discharge channel being communicated with a discharge port, an attaching member inserted into the main body and protruding to a container side of the main body, and including a connection portion at a distal end of the attaching member, the connection portion being connected to a container discharge portion, and an insertion portion provided in the main body, the attaching member rotatably penetrating through the insertion portion, the insertion portion being communicated with the valve body housing portion.

### CROSS-REFERENCE TO RELATED APPLICATION

This application is based upon and claims the benefit of priority of the prior Japanese Patent Application No. 2020-76387, filed on Apr. 22, 2020, and Japanese Patent Application No. 2020-186212, filed on Nov. 6, 2020, the entire contents of which are incorporated herein by reference.

### TECHNICAL FIELD

The present disclosure relates to an on-off valve.

### BACKGROUND

The applicant has proposed an on-off valve that is attached to a discharge port of a liquid container. In this on-off valve attached to the discharge opening of the liquid container as described in Japanese Unexamined Patent Application Publication No. 2017-36828, a ball valve provided within the on-off valve is operated to rotate and switch the ball valve between an open position and a closed position, which controls discharge of liquid. In order to adjust a direction of a discharge opening of the on-off valve and a position of an operating lever for opening/closing operation, a proximal end of a valve body is provided with a housing portion into which an attaching member is inserted, the discharge opening is rotated about the attaching member to any direction, and the valve body is tightened and fixed.

In the on-off valve described above, the valve body is tightened and fixed to the container with the attaching member, so the attaching member is rotated sufficiently to tighten and fix the valve body to the container discharge opening. However, if the tightening is done with ordinary tightening tools, the tightening force might vary depending on the operator's skill level. The tightening force is weak in some cases, and the tightening force is strong in other cases. When the tightening force is weak, liquid might leak from a tightened portion, or the valve body might rotate relative to the attaching member and might move from an initial set direction.

In addition, when the tightening force is strong, the screw threads might be crushed. This problem might be especially noticeable when the valve body is made of resin. Furthermore, in a case where the valve body is made of resin, creep phenomenon might occur easily, as compared with a case where the valve body is made of metal. Thus, the above problems might occur easily due to loosening of the screws.

### SUMMARY

An object of the present disclosure is to provide an on-off valve including: a valve body housed in a valve body housing portion provided in a main body, the valve body being switchable between an open position and a closed position; an operating means switching the valve body between the open position and the closed position; a discharge channel, one end of the discharge channel being communicated with a valve chamber of the main body, another end of the discharge channel being communicated with a discharge port; an attaching member inserted into the main body and protruding to a container side of the main body, and including a connection portion at a distal end of the attaching member, the connection portion being connected to a container discharge portion; and an insertion portion provided in the main body, the attaching member rotatably penetrating through the insertion portion, the insertion portion being communicated with the valve body housing portion, wherein when the valve body is located in the open position, a fluid is permitted to flow between the discharge port and the insertion portion, when the valve body is in the closed position, the fluid is restricted from flowing between the discharge port and the insertion portion, the attaching member, in an attached state where the main body is connected to the container discharge portion, includes: an inlet opening that opens into the container; an outlet opening that opens into the insertion portion and is connected to the inlet opening; a protruding portion provided at a proximal end and protruding to an opposite side of the container in the insertion portion; and a locking means locking a relative position between the attaching member and the main body in a state where the protruding portion protrudes from the insertion portion, in a state where the attaching member is inserted into the insertion portion, a posture of the main body relative to the container is fixed by connecting the connection portion to the container discharge portion.

### BRIEF DESCRIPTION OF THE DRAWINGS

FIG. 1 is a cross-sectional side view of an on-off valve with attaching structure in a first embodiment;

FIG. 2 is an overall perspective view of the on-off valve with attaching structure in the first embodiment;

FIG. 3 is an exploded perspective view of the on-off valve with the attaching structure in the first embodiment;

FIG. 4 is an exploded perspective view of an attaching member of the on-off valve with the attaching structure in the first embodiment;

FIG. 5 is a bottom view of a cover of the on-off valve with the attaching structure in the first embodiment;

FIG. 6 is a cross-sectional exploded perspective view of the on-off valve with the attaching structure in the first embodiment;

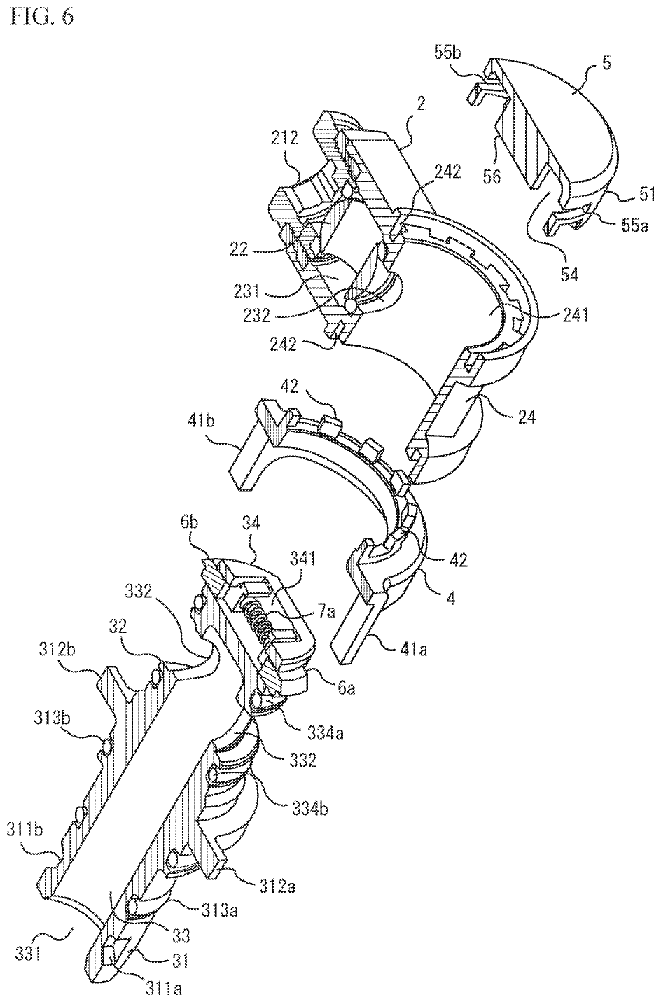

FIG. 7 is a cross-sectional exploded perspective view of an on-off valve with an attaching structure in a second embodiment;

FIG. 8 is a cross-sectional side view of the on-off valve with the attaching structure in the second embodiment;

FIG. 9 is an overall perspective view of an on-off valve with an attaching structure in a third embodiment;

FIG. 10 is an exploded perspective view of the on-off valve with the attaching structure in the third embodiment;

FIG. 11 is an exploded perspective view of a locking means of the attaching structure in the third embodiment; and

FIG. 12 is a cross-sectional side view of the locking means of the attaching structure in the third embodiment.

### DETAILED DESCRIPTION

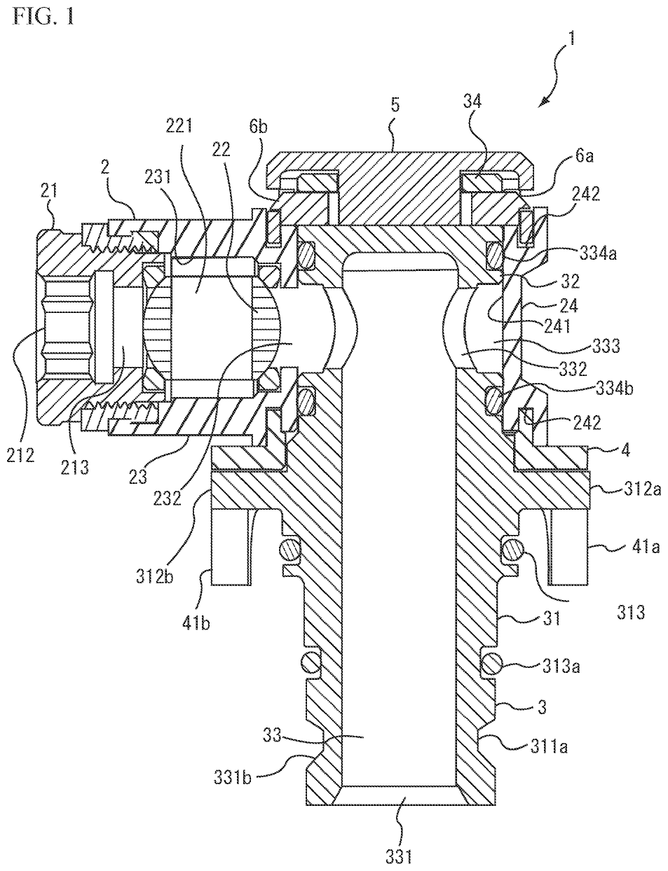

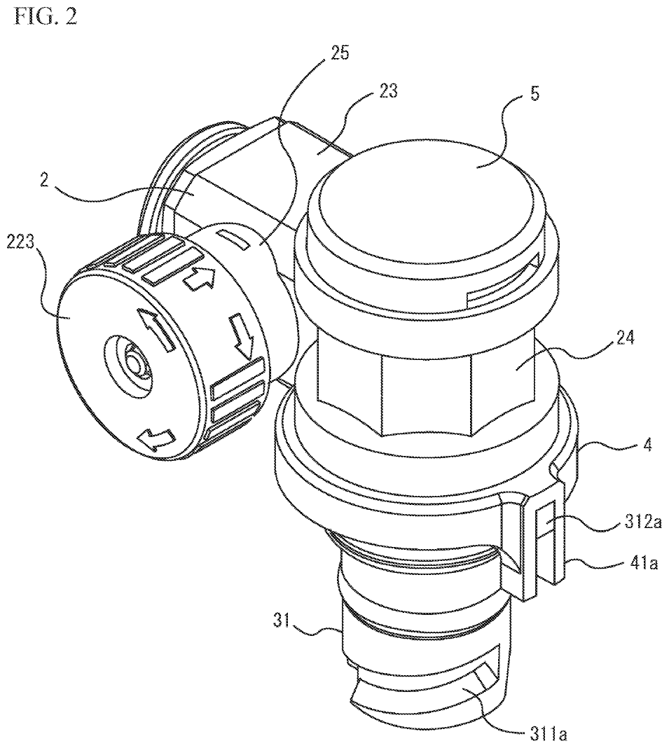

A first embodiment will be described in detail with the accompanying drawings. FIG. 1 is a cross-sectional side view of an on-off valve 1. FIG. 2 is an overall perspective view thereof. The on-off valve 1 includes a main body 2, an attaching member 3, and a lid 21. The main body 2 includes a valve body housing portion 23 housing a valve body 22, an insertion portion 24 into which the attaching member 3 is inserted into and which houses the vicinity of a proximal end thereof, and an operation housing portion 25 which houses a mechanism for opening and closing the valve body 22.

A valve chamber 231 housing the valve body 22 is provided within the valve body housing portion 23. A flow portion 232 communicated to the insertion portion 24 described later is provided at the innermost part of the valve chamber 231. A discharge channel 213 is provided on the opposite side of the flow portion 232. A distal opening of the discharge channel 213 serves as a discharge opening 212. These discharge channel 213 and the discharge opening 212 are formed within the lid 21. The lid 21 serves as a cover member to seal the valve chamber 231 formed in the main body 2. The discharge opening 212, the discharge channel 213, the valve chamber 231, and the flow portion 232 are arranged on an axis so as to form a discharge flow channel, and this axis connecting them is orthogonal to another axis on which the insertion portion 24 and the operation housing portion 25 are located.

The valve body 22 formed into a spherical shape is housed in the valve chamber 231. A passage 221 is formed along an axis on the center of the valve body 22. One end of a connecting shaft is connected to the axis of the passage 221 orthogonal thereto. An operating member 223 is connected to the other end of the connecting shaft. The operating member 223 is a cylindrical dial, and the other end of the connecting shaft is connected to the center of this cylindrical body. When the operating member 223 is rotated, the valve body 22 is rotated together through the connecting shaft. That is, the rotation of the operating member 223 by 90 degrees causes the valve body 22 to rotate in a range of 90 degrees. A position where the passage 221 overlaps the discharge flow channel in parallel is an opening position to permit fluid to flow. A position where the passage 221 is orthogonal to the discharge flow channel is a closed position to restrict fluid from flowing. In FIG. 1, the valve body 22 is in the closed position.

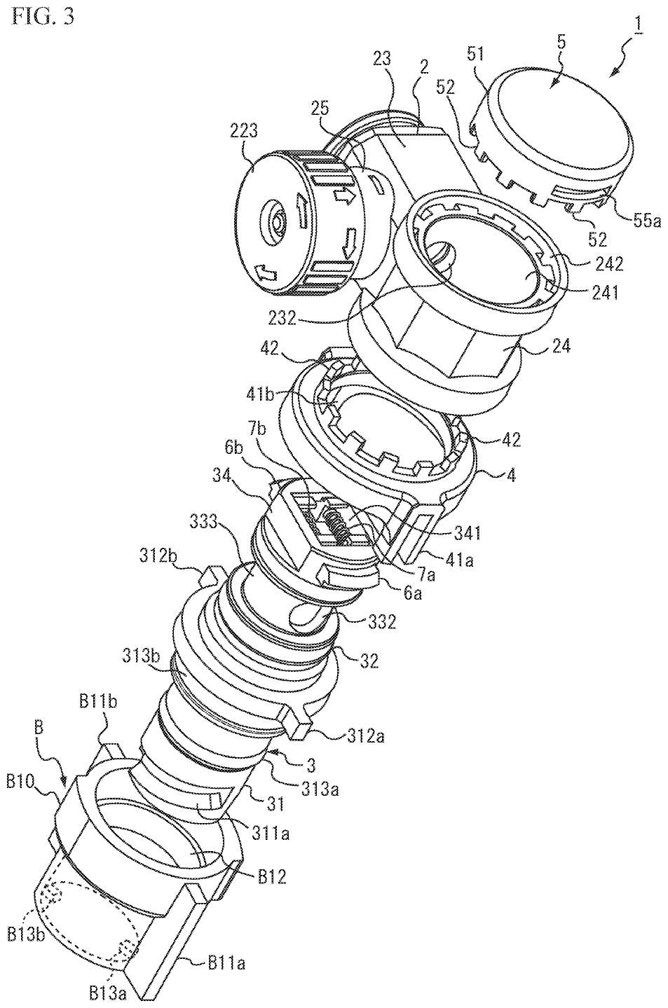

Next, the insertion portion 24 and the attaching member 3 will be described. The insertion portion 24 is formed into a cylindrical shape, and an insertion housing portion 241 formed inside thereof houses a proximal end of the attaching member 3. The insertion housing portion 241 has a cylindrical shape with openings at both ends thereof. The shape of the insertion housing portion 241 is linearly symmetrical with respect to the axis of the discharge flow channel in the cross-sectional side view in FIG. 1. A plurality of recess portions 242 (engagement portions) each having the same shape are provided at equal intervals along the opening periphery of both end openings of the insertion housing portion 241 as illustrated in FIG. 3. In this embodiment, the recess portions 242 are arranged so as to set a 30-degree angle between adjacent recess portions 242 at the center of the opening. This configuration allows the setting angle of the on-off valve 1 relative to the container to be changed every 30 degrees.

The attaching member 3 is a cylindrical member, and includes a connecting portion 31 at a distal end; a housed portion 32 at a proximal end, a flow channel 33 formed inside from the connecting portion 31 to the housed portion 32, and a protruding portion 34 at the proximal end. The connection portion 31 at the distal end has an outer diameter that is the same as an inner diameter of the connection hole B12 in a container discharge portion B on the container side. The connection portion 31 is inserted into the connection hole B12. The container discharge portion B is a cylindrical body B10 connected to the container, and includes the connection hole B12 formed on a cylindrical inner side, and a pair of engagement pieces B11a and B11b disposed at opposite positions on the outer periphery.

An inlet opening 331 is formed at the distal end of the connection portion 31. Liquid in the container flows into the flow channel 33 from the inlet opening 331. Grooves 311a and 311b each having a helical shape are formed in opposing positions on the outer periphery of the connecting portion 31. When the connection portion 31 is inserted into the connection hole B12, a pair of protrusions B13a and B13b protruding from the inside of the connection hole B12 are respectively fitted into the grooves 311a and 311b. In this state, the attaching member 3 is rotated and moved in the axial direction, which respectively permits the protrusions B13a and B13b to move relatively in the grooves 311a and 311b. Thus, the attaching member 3 is fitted into the connection hole B12. Packings 313a and 313b arranged on the outer periphery of the connection portion 31 seal a gap between the connection portion 31 and the connection hole B12.

Between the connection portion 31 and the housed portion 32, engaged pieces 312a and 312b protrude outward. Container-side engaged pieces B11a and B11b each having the same thickness as each of the engaged pieces 312a and 312b are provided. When the attaching member 3 is attached to the connection hole B12 of the container discharge portion B, the engaged pieces 312a and 312b positionally overlap the container-side engaged pieces B11a and B11b, respectively. On the other hand, an attachment 4 having a ring shape is exteriorly attached to the attaching member 3. The attachment 4 is provided with slit portions 41a and 41b extending in the axial direction and located at opposite positions thereof. The slit portions 41a and 41b of the attachment 4, serving as a rotation fixing member, simultaneously house the engaged piece 312a and the container-side engaged piece B11a and the engage piece 312b and the container-side engaged piece B11b that positionally overlap each other, respectively. This restricts the attaching member 3 from rotating relative to the container. This configuration prevents the attaching member 3 from being detached from the container.

As illustrated in FIG. 3, the attachment 4 is provided with protrusions 42 arranged in the circumferential direction. The protrusions 42 engage the recess portions 242 (engagement portions) provided at the periphery of the both end openings of the insertion housing portion 241. The protrusion 42 has the same shape as the recess portion 242. The protrusions 42 are arranged at the same intervals as the recess portions 242. The protrusions 42 are respectively fitted into the recess portions 242, which restricts the main body 2 from rotating relative to the attaching member 3. It is thus possible to set and fix the rotational position between the attaching member 3 and the main body 2 at every 30 degrees.

On the other hand, a groove 333 is formed on the outer periphery of the housed portion 32. A bottom of the groove 333 is provided with an outlet opening 332 communicated to the flow channel 33. Packings 334a and 334b arranged on opposite sides of the groove 333 rotatably seal a gap between the housed portion 32 and the insertion housing portion 241. In the state where the housed portion 32 is housed in the insertion housing portion 241, the groove 333 serving as a liquid flow portion is communicated to the valve chamber 231 through the flow portion 232.

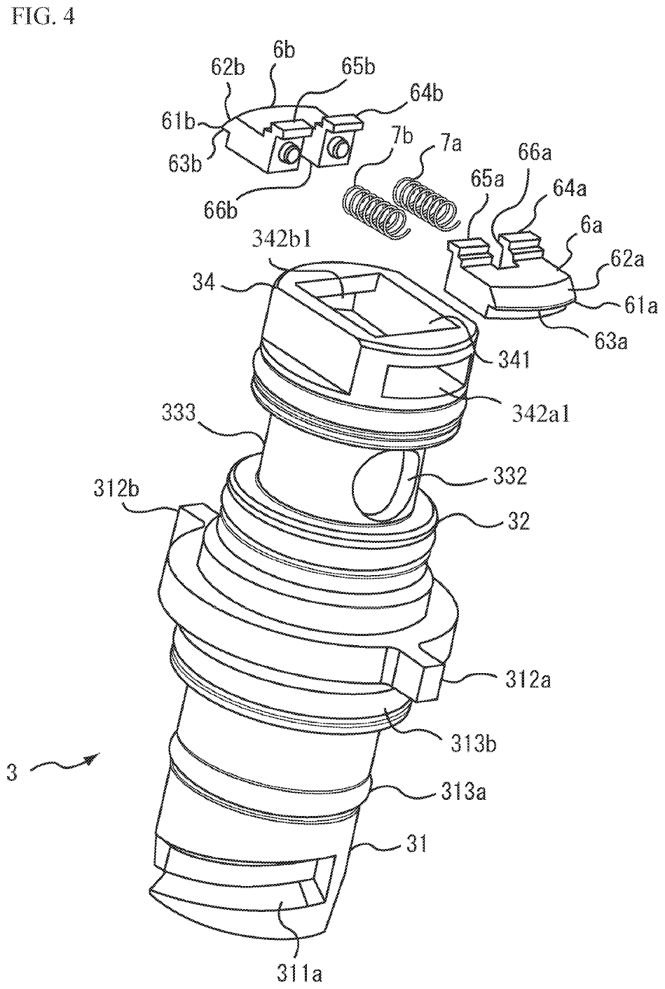

As illustrated in FIG. 4, the protruding portion 34 at the proximal end of the attaching member 3 is provided with a claw housing portion 341 formed on the proximal end surface thereof and having a recess shape. The claw housing portion 341 houses a pair of claw members 6a and 6b serving as movement restriction members. The claw members 6a and 6b serving as the movement restriction members respectively include claw portions 61a and 61b protruding outward from the protruding portion 34. The claw portions 61a and 61b includes slopes 62a and 62b and flat portions 63a and 63b formed on the opposite sides of the slopes 62a and 62b, respectively. On the opposite sides of the claw members 6a and 6b, that is, on the opposite sides of the claw portions 61a and 61b, spring receiving portions 64a, 65a, 64b, and 65b are provided at ends, respectively. A gap 66a is provided between the spring receiving portions 64a and 65a. A gap 66b is provided between the spring receiving portions 64b and 65b. A spring 7a serving as an urging member is interposed between the spring receiving portions 64a and 64b. A spring 7b serving as an urging member is interposed between the spring receiving portions 65a and 65b. The springs 7a and 7b urge the claw members 6a and 6b in such a direction that the claw portions 61a and 61b protrude outward, respectively.

The claw housing portion 341 is provided, at its opposite inner wall surfaces, with windows 342a1 and 342b1 opening to the outer peripheral surface thereof. The claw portions 61a and 61b of the claw members 6a and 6b protrude outward from the windows 342a1 and 342b1, respectively. By pushing the claw members 6a and 6b from the outside, the springs 7a and 7b are compressed and deformed to push the claw portions 61a and 61b into the windows 342a1 and 342b1, respectively.

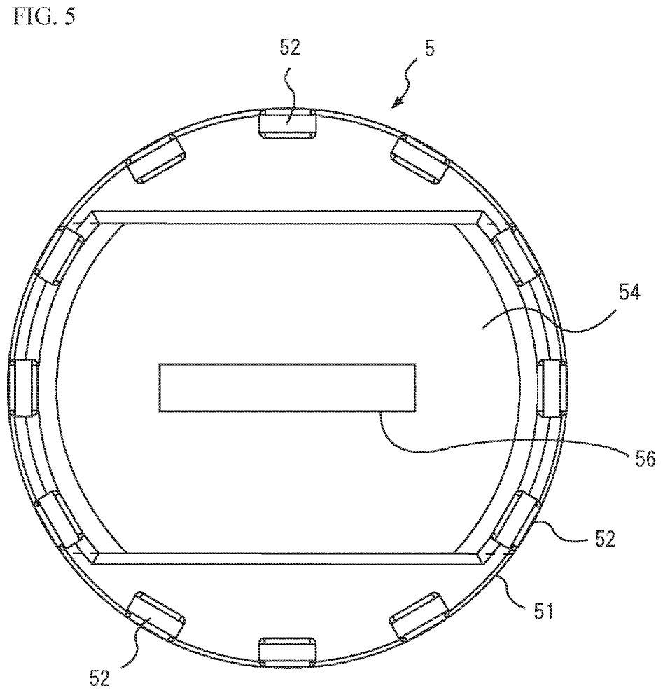

The protruding portion 34 is covered with a cover 5. As illustrated in FIG. 5, the cover 5 is formed into a disk shape. At the bottom of the cover 5, a housing recess portion 54 housing the protruding portion 34 is provided. At the center of the housing recess portion 54, a protrusion is formed as an insertion portion 56 serving as a lock fixing member. Slit openings 55a and 55b are formed in a peripheral surface 51 of the cover 5. The claw portions 61a and 61b of the claw members 6a and 6b are engaged in the slit openings 55a and 55b, respectively. On the peripheral edge of the lower surface of the cover 5, protrusions 52 are formed in the circumferential direction. The protrusions 52 engage the recess portions 242 (engagement portion) provided on the peripheral edges of the both opening ends of the insertion housing portion 241. The protrusion 52 has the same shape as the recess portion 242. The protrusions 52 are arranged at the same intervals as the recess portions 242.

The protrusions 52 are fitted into the recess portions 242. This restricts the main body 2 from rotating relative to the attaching member 3, and sets and fixes the rotational position between the attaching member 3 and the main body 2 at every 30 degrees. The circumferential intervals of the recess portions 242 and the protrusion 52 defines the minimum unit of the setting angle of the rotation of the main body 2 relative to the attaching member 3. The cover 5 is fitted onto the protruding portion 34, so the insertion portion 56 is inserted between the claw members 6a and 6b, which restricts the claw members 6a and 6b from being retracted into the windows 342a1 and 342b1, respectively.

The claw portions 61a and 61b are respectively positioned within the slit openings 55a and 55b, which prevents the cover 5 from being detached from the protruding portion 34 of the attaching member 3. The protrusions 52 of the cover 5 and the protrusions 42 of the attachment 4 serve as a locking means (angle locking means) for fixing the rotational position of the main body 2 rotatable about the attaching member as a rotational axis. The cover 5 with the protrusions 52 and the attachment 4 with the protrusions 42 serve as a rotation restriction member.

With the above configuration, the attaching procedure will be described below. The connection portion 31 of the attaching member 3 is inserted into a connection hole of the container connection portion, and further inserted into a fixed position while being rotated. The attachment 4 is inserted onto the attaching member 3 from the proximal end thereof, and the engaged pieces 312a and 312b are respectively fitted into the slit portions 41a and 41b of the attachment 4. This restricts the attaching member 3 from rotating relative to the container. Next, the housed portion 32 of the attaching member 3 is fitted into the opening of the insertion housing portion 241. At this time, the posture of the operating member 223 relative to the container is determined depending on the opening selected among the openings provided at both ends of the insertion housing portion 241. When the protruding portion 34 of the attaching member 3 is inserted into the insertion housing portion 241, the edge of the opening of the insertion housing portion 241 comes into contact with and slides on the slopes 62a and 62b of the claw portions 61a and 61b, and then the claw members 6a and 6b are retracted inward. When the protruding portion 34 protrudes from the opening on the other side, the springs 7a and 7b respectively push the claw members 6a and 6b, so that the claw portions 61a and 61b protrude outward from the inner diameter of the insertion housing portion 241, and the flat portions 63a and 63b of the claw portions 61a and 61b come into contact with the opening edge of the insertion housing portion 241. This prevents the housed portion 32 from being detached from the insertion housing portion 241.

Furthermore, when the cover 5 covers the protruding portion 34, a peripheral end portion of the cover 5 slides on the slopes 62a and 62b of the claw members 6a and 6b, which retracts the claw members 6a and 6b inward. When the slit openings 55a and 55b respectively overlap the claw portions 61a and 61b, the claw portions 61a and 61b protrude into the slit openings 55a and 55b to fix the cover 5.

The claw members 6a and 6b act to fix the attaching member 3 to the insertion housing portion 241 and to fix the cover 5. It is possible to set the rotational angle of the main body 2 relative to the attaching member 3, as long as either the protrusions 42 of the attachment 4 or the protrusions 52 of the cover 5 is provided. The locking means including the cover 5, the attaching member 3, the claw members 6a and 6b, the protruding portion 34, and the springs 7a and 7b described above is useful, in a case where they are made of resin.

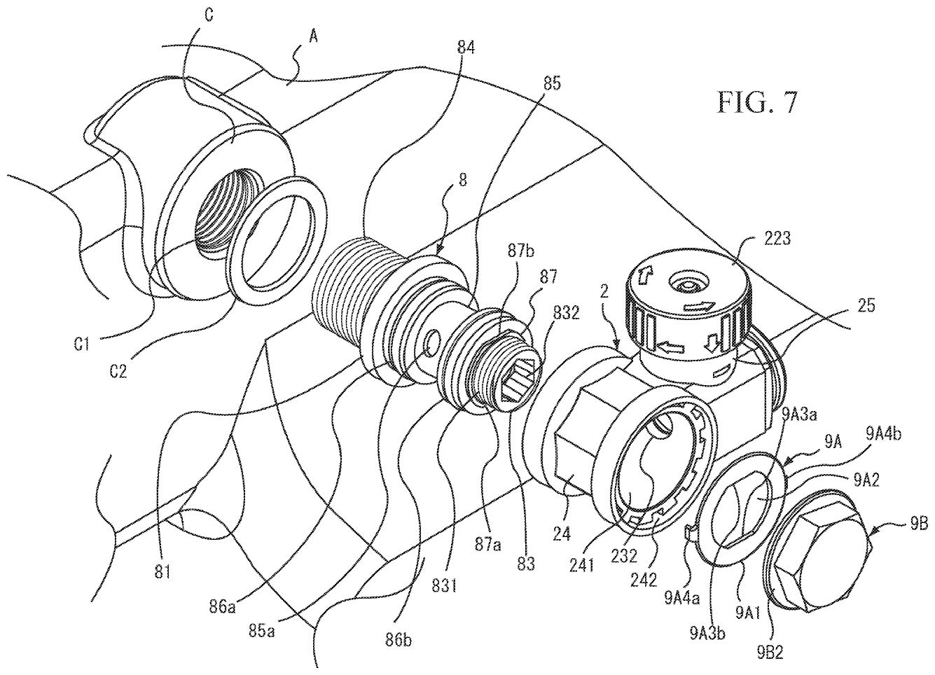

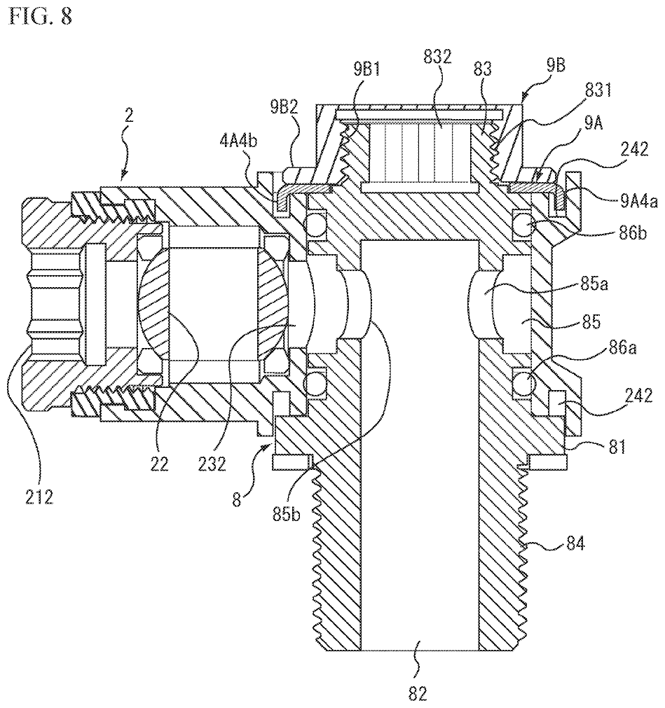

FIG. 7 is a cross-sectional exploded perspective view of an on-off valve with an attaching structure in a second embodiment. FIG. 8 is a cross-sectional side view of the on-off valve with the attaching structure in the second embodiment. In the on-off valve in this embodiment, the configuration of the main body 2 is similar to that of the previously described embodiment, so the description is omitted. An attaching member 8 formed into a cylindrical shape includes a connecting portion 84 at a distal end, a housed portion 85 at a proximal end, a flow channel 82 formed inside from the connecting portion 84 to the housed portion 85, and a protruding portion 83 at the proximal end. The connecting portion 84 on the distal end side is provided, on its outer periphery, with a male thread having the same diameter as a female thread of a connection hole C1 provided in a container discharge portion C of a container A. A flange 81 is formed on all periphery on the proximal end side of the connecting portion 84. A packing C2 is sandwiched between the flange 81 and the connection hole C1 in a connected and fixed state.

The housed portion 85 is formed with a groove extending in the circumferential direction, and is formed with outflow opening portions 85a and 85b on the opposite surfaces. Packings 86a and 86b are exteriorized on both sides sandwiching the groove, which ensures liquid tightness of the flow path of the housed portion 85 formed by the groove. The protruding portion 83 protrudes in the axial direction on the proximal end surface of the attaching member 8. A male thread 831 is formed on the outer periphery of the protruding portion 83. A hole 832 having a hexagonal shape is formed inside the protruding portion 83. A step portion 87 having a circular shape is formed at a base portion of the protruding portion 83. Step portions 87a and 87b each having a straight shape in parallel with each other are respectively formed at opposite positions of the step portion 87.

The step portion 87 is fitted onto a rotation restriction member 9A having a ring shape. Straight portions 9A3a and 9A3b facing each other are respectively provided at the inner opposite positions of the rotation restriction member 9A. The straight portions 9A3a and 9A3b respectively fit to the step portions 87a and 87b each having a straight shape. Additionally, protruding claws 9A4a and 9A4b are respectively provided at the opposite outer peripheral ends of the rotation restriction member 9A, and are bent in the axial direction. These protruding claws 9A4a and 9A4b are fitted into the recess portions 242. The rotation restriction member 9A is unitized with the attaching member 8 by fitting the inner straight portions 9A3a and 9A3b to the straight step portions 87a and 87b. Also, the rotation restriction member 9A is unitized with the main body 2 by fitting the protruding claws 9A4a and 9A4b into the recess portions 242. That is, the rotation restriction member 9A unitizes the attaching member 8 and the main body 2 so as not to be rotated. By selecting the position of the recess portions 242 into which the protruding claws 9A4a and 9A4b are fitted, the setting angle is changed every 30 degrees, which is the interval angle of the recess portions 242. Such a rotation restriction member 9A is fastened and fixed by a nut member 9B serving as a fixing member screwed onto the protruding portion 83. An outer shape of the nut member 9B is a hexagonal-nut shape, and an inner side of the nut member 9B is provided with a female screw 9B1 that screws onto the protruding portion 83. The outer periphery of the opening of the female screw 9B1 is provided with a contacting portion 9B2 having a flange shape. By tightening the nut member 9B, the contacting portion 9B2 fixes the rotation restriction member 9A.

To attach the on-off valve to the container A, the connecting portion 84 of the attaching member 8 is inserted into the connecting hole C1, and a tool is inserted and screwed into the hexagonal hole formed on the distal end surface of the protruding portion 83. Next, the housed portion 85 of the attaching member 8 is inserted into the insertion portion 24 of the main body 2. At this point, when the protruding portion 83 of the attaching member 8 protrudes from the insertion portion 24, the angle of the main body 2 relative to the container A is determined, and the rotation restriction member 9A is fitted into the main body 2. In this way, the angle position of the main body 2 relative to the container A is fixed to maintain this angle. Next, the nut member 9B is tightened and fixed to the protruding portion 83 to complete the attachment.

With the configuration described above, the attachment angle is easily determined based on the interval of the recess portions 242, and attaching work is uniformed without relying on the skill of the operator. In the configuration described in FIGS. 7 and 8, the hole 832 may be a female screw, the male thread 831 at the outer periphery may be a hexagonal bolt, a bolt may be provided at the center of the inner ceiling instead of the female screw 9B1 provided inside the nut member 9B, and this bolt may be screwed into a female screw instead of the hole 832.

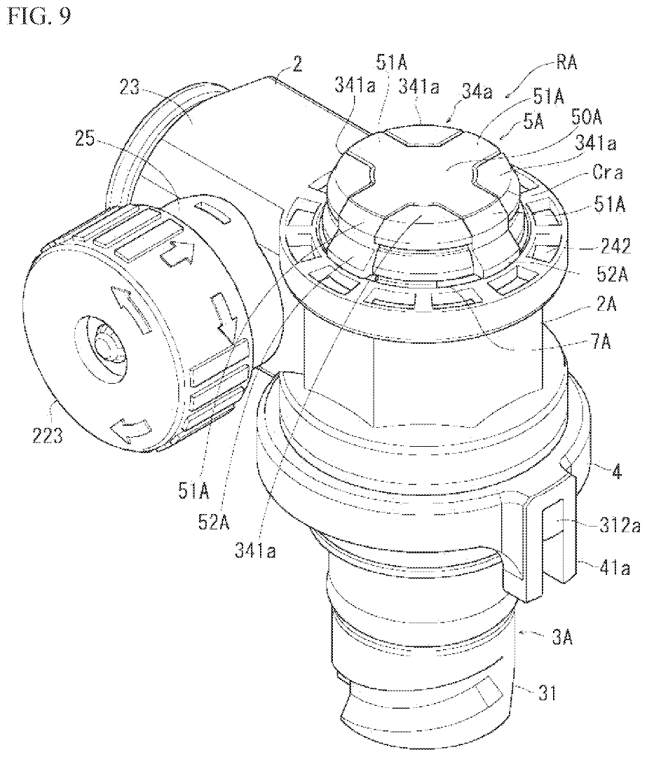

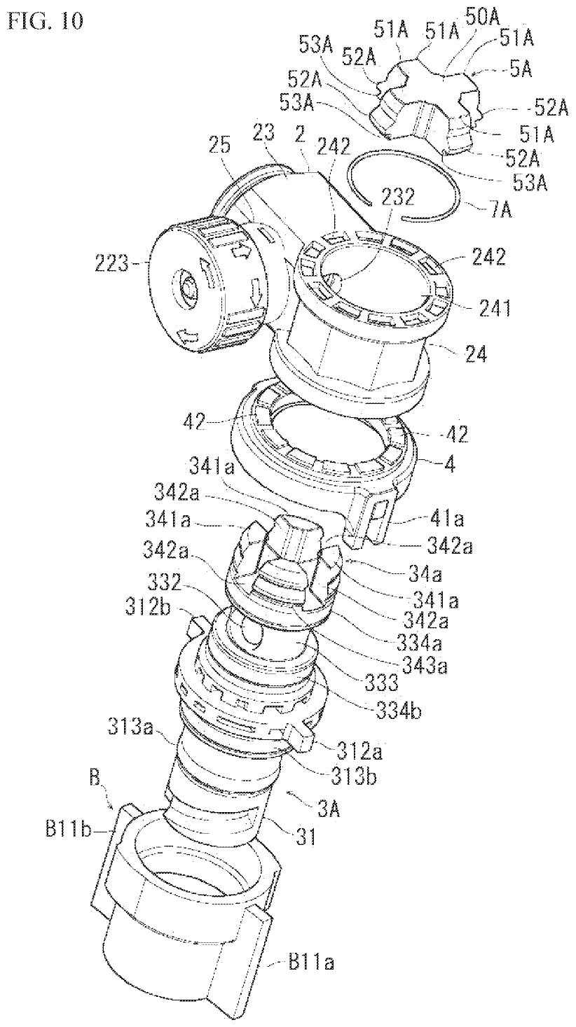

FIG. 9 illustrates an overall perspective view of an on-off valve with an attaching structure according to another embodiment, and FIG. 10 illustrates an exploded perspective view of the same valve. In this embodiment of the on-off valve, the configuration of the main body 2 is identical to that of the previously described embodiment, so the description is omitted. As for an attaching member 3A, the same components as those in the first embodiment are designated by the same reference numerals, and duplicated description is omitted.

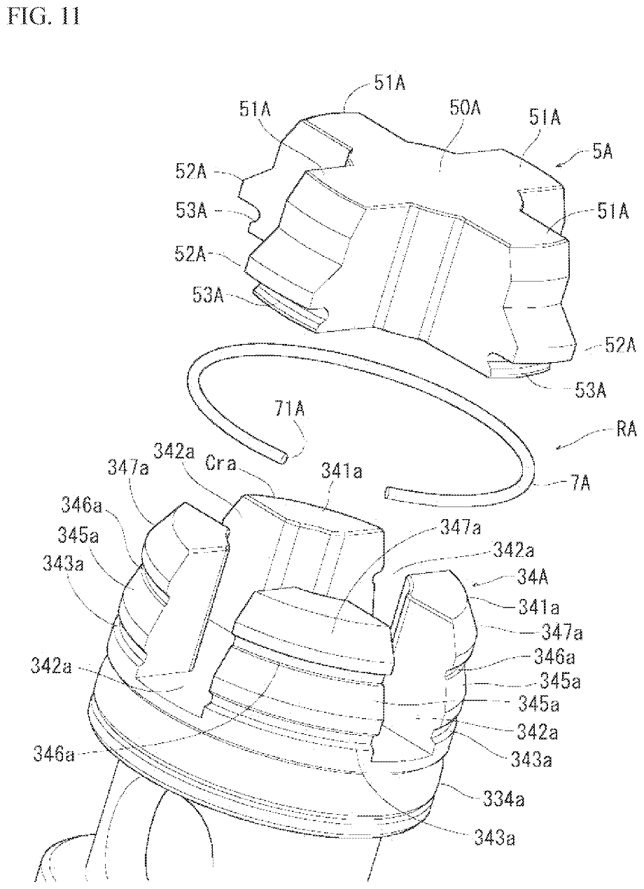

As illustrated in FIG. 11, a locking means RA is provided at the proximal end of the attaching member 3A. At the proximal end of the attaching member 3A, the locking means RA includes a proximal end protruding portion 34A formed to protrude in the axial direction, an insertion/removal restricting member 5A fitted into the proximal end protruding portion 34A, and a locking member 7A. The proximal end protruding portion 34A includes a second engagement groove 343a, an inclined surface 345a, and a groove 346a. The second engagement groove 343a into which the locking member 7A is fitted is formed circumferentially at the proximal end. The inclined surface 345a is formed such that the cross-sectional diameter decreases from the second engagement groove 343a toward the proximal end. The groove 346a is formed circumferentially on the proximal end side of the inclined surface 345a. On the proximal end side of the groove 346a, the diameter increases. Further, each of the inclined surfaces 345a and 347a is formed to reduce the cross-sectional diameter toward the proximal end. The proximal end protruding portion 34A is formed with four fitting grooves 342a that are orthogonal to one another in the center.

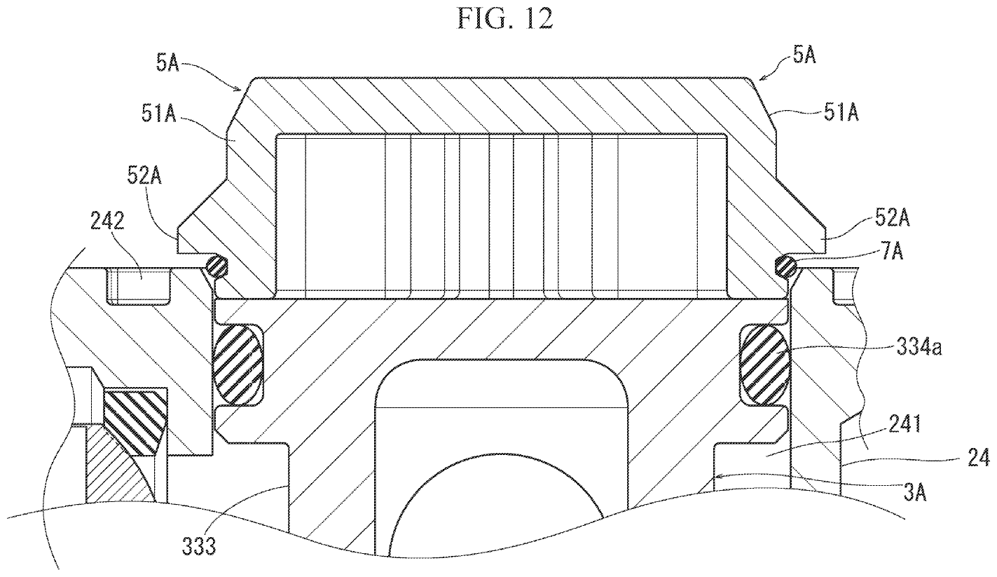

The fitting grooves 342a are fitted with the insertion/removal restricting member 5A. The insertion/removal restricting member 5A includes four fitting portions 51A protruding from a center portion 50A and shaped in the form of a cross in side view. Further, engagement portions 52A are respectively provided at the distal ends of the fitting portions 51A. The engagement portion 52A protrudes outward from a side surface of the fitting portion 51A, and includes a flat surface on the lower side. Furthermore, at the proximate portion of the engagement portion 52A, a first engagement groove 53A is formed on the opening end side (insertion portion 24 side) of the side surface of the fitting portion 51A. An inner wall of the first engagement groove 53A is continuous with the flat surface of the engagement portion 52A. The first engagement grooves 53A respectively formed in the four fitting portions 51A are arranged on a circle when the first engagement grooves 53A are connected to one another. A diameter of this circle is smaller than an inner diameter of the insertion portion 24. The distal ends of the engagement portions 52A are arranged on a circle. A diameter of this circle connecting the distal ends is greater than the inner diameter of the insertion portion 24. That is, as illustrated in FIG. 12, the engagement portion 52A protrudes outward with respect to the inner circumference of the insertion portion 24.

On the other hand, as illustrated in FIG. 9, when the insertion/removal restricting member 5A is fitted to the proximal end protruding portion 34A, the first engagement groove 53A and the second engagement groove 343a are connected to each other so as to form a locking groove continuous in the circumferential direction. The locking member 7A is fitted into this locking groove. The locking member 7A is a C-ring made of a wire material such as an elastic material. Its diameter is expanded or reduced by elastic deformation. When the locking member 7A is fitted into the locking groove, the C-ring is in an expanded diameter state, and the C-ring tightens the lock groove. In this way, the locking member 7A is simultaneously fitted into the first engagement groove 53A and the second engagement groove 343a, thereby suppressing insertion/removal restricting member 5A from being detached from the proximal end protruding portion 34A. In this state, the outer diameter of the locking member 7A is greater than the inner diameter of the insertion portion 24. As illustrated in FIG. 12, when the attaching member 3A tries to relatively move in such a direction (axial direction) to be removed from the insertion portion 24, the locking member 7A comes into contact with the opening end of the insertion portion 24 to restrict this relative movement. In addition, the engagement portion 52A restricts the movement of the locking member 7A in the axial direction.

In such a configuration, the method of assembling the locking means RA to be brought into a locked state will be described. The locking member 7A is fitted into the groove 346a of the proximal end protruding portion 34A. A diameter of the outer edge of the proximal end portion Cra of the proximal end protruding portion 34A is smaller than the inner diameter of the locking member 7A. Thus, the locking member 7A is fitted onto the outside of the proximal end portion Cra, and is pushed downward so as to expand the diameter of the locking member 7A along the inclined surfaces 347a. This facilitates fitting the locking member 7A onto the groove 346a.

Next, the insertion/removal restricting member 5A is pushed from above so as to respectively insert the fitting portions 51A of the insertion/removal restricting member 5A into the fitting grooves 342a. A bottom surface of the insertion/removal restricting member 5A pushes the locking member 7A downward, and then the locking member 7A is pushed downward and expanded by the inclined surfaces 345a. When the diameter of the locking member 7A reaches the diameter of the first engagement groove 53A, the locking member 7A is fitted into the first engagement grooves 53A. The insertion/removal restricting member 5A is further pushed to further expand the locking member 7A by the inclined surfaces 345a. When the first engagement grooves 53A are continuous with the second engagement grooves 343a, that is, when the fitting portions 51A of the insertion/removal restricting member 5A are completely fitted into the fitting grooves 342a, the locking member 7A is fitted into the locking groove and is brought into a locked state (illustrated in FIGS. 9 and 12).

Another method of assembling the locking means RA to be brought into the locked state may be performed below. First, the locking member 7A may be fitted onto the first engagement grooves 53A of the insertion/removal restricting member 5A, and then the fitting portions 51A of the insertion/removal restricting member 5A may be inserted into the fitting grooves 342a.

Although some embodiments of the present disclosure have been described in detail, the present disclosure is not limited to the specific embodiments but may be varied or changed within the scope of the present disclosure as claimed.

What is claimed is:

1. An on-off valve comprising:
a valve body housed in a valve body housing portion provided in a main body, the valve body being switchable between an open position and a closed position;
an operating means switching the valve body between the open position and the closed position;
a discharge channel, one end of the discharge channel being communicated with a valve chamber of the main body, another end of the discharge channel being communicated with a discharge port;
an attaching member inserted into the main body and protruding to a container side of the main body, and including a connection portion at a distal end of the attaching member, the connection portion being connected to a container discharge portion; and
an insertion portion provided in the main body, the attaching member rotatably penetrating through the insertion portion, the insertion portion being communicated with the valve body housing portion,
wherein
when the valve body is located in the open position, a fluid is permitted to flow between the discharge port and the insertion portion,
when the valve body is in the closed position, the fluid is restricted from flowing between the discharge port and the insertion portion,
the attaching member, in an attached state where the main body is connected to the container discharge portion, includes:
an inlet opening that opens into the container;
an outlet opening that opens into the insertion portion and is connected to the inlet opening;
a protruding portion provided at a proximal end and protruding to an opposite side of the container in the insertion portion; and
a locking means locking a relative position between the attaching member and the main body in a state where the protruding portion protrudes from the insertion portion,
in a state where the attaching member is inserted into the insertion portion, a posture of the main body relative to the container is fixed by connecting the connection portion to the container discharge portion.

2. The on-off valve of claim 1, wherein the locking means fixes a position of the main body, and a position of the attaching member inserted into the insertion portion of the main body, in an axial direction of the attaching member.

3. The on-off valve of claim 2, wherein
the locking means includes:
a movement restriction portion capable of radially protruding to and retracting from a peripheral surface of the protruding portion, and capable of moving between a restriction position where the movement restriction portion partially protrudes from the peripheral surface and a release position where the movement restriction portion retracts inside; and
an urging member urging the movement restriction portion to the restriction position.

4. The on-off valve of claim 3, comprising a lock fixing member connected to the protruding portion to fix the movement restriction member in the restriction position.

5. The on-off valve of claim 2, wherein
the locking means includes:
a male thread portion formed on the protruding portion; and
a tightening restriction member, the tightening restriction member includes:
a female thread portion screwed onto the male thread portion; and
a contact portion contacting an opening end of the insertion portion.

6. The on-off valve of claim 1, wherein the locking means includes the attaching member into which the insertion portion of the main body is inserted, and fixes a rotational position of the main body about the attaching member as a rotational axis.

7. The on-off valve of claim 6, comprising:
engagement portions arranged at predetermined intervals in a circumferential direction on an outer side of an opening of the insertion portion; and
a rotation restriction member fixed to the protruding portion and engaging the engagement portions to restrict rotation of the attaching member relative to the insertion portion.

8. The on-off valve of claim 2, wherein
the locking means includes:
a movement restriction portion capable of radially protruding to and retracting from a peripheral surface of the protruding portion, and capable of moving between a restriction position where the movement restriction portion partially protrudes from the peripheral surface and a release position where the movement restriction portion retracts inside; and
an urging member urging the movement restriction portion to the restriction position,
the on-off valve includes:
engagement portions arranged at predetermined intervals in a circumferential direction on an outer side of an opening of the insertion portion; and
a rotation restriction member fixed to the protruding portion and engaging the engagement portions to restrict rotation of the attaching member relative to the insertion portion, and
the rotation restriction member is fixed to the attaching member by the movement restriction member protruding from a periphery of the protruding portion.

9. The on-off valve of claim 6, comprising:
engagement portions arranged at predetermined intervals in a circumferential direction on an outer side of an opening of the insertion portion; and
a rotation fixing member fixed to the container and engaging the engagement portions to restrict rotation of the attaching member relative to the insertion portion.

10. The on-off valve of claim 9, wherein the rotation fixing member connects a peripheral end of the attaching member to a periphery of the container discharge portion and restrict rotation of the attaching member relative to the container discharge portion.

11. The on-off valve of claim 7, wherein the engagement portions are provided at both opening ends of the insertion portion.

12. The on-off valve of claim 2, wherein
the locking means includes:
a locking member made of an elastic wire material;
an insertion/removal restriction member attached to the protruding portion and including an engagement portion extending outward from an opening end portion of the insertion portion, a fitting portion fitted into the protruding portion, and a first engagement groove for engaging the locking member; and
a second engagement groove formed on an outer periphery of the protruding portion,
the locking member simultaneously engages the first engagement groove and the second engagement groove to lock a relative position of the attaching member and the main body in a state where the insertion/removal restriction member is attached to the protruding portion.

13. The on-off valve of claim 12, wherein
the locking member is an elastic wire having a ring shape, and is elastically deformed to deform an inner diameter in expanding and contracting directions, and
the outer peripheral surface of the protruding portion includes an inclined surface that decreases in diameter toward a distal end of the protruding portion.

14. The on-off valve of claim 12, wherein the first engagement groove is located close to the opening end portion with respect to the engagement portion.
